(19) United States
(12) Patent Application Publication
(10) Pub. No.: US 2005/0016345 A1
(43) Pub. Date: Jan. 27, 2005

(54) Apparatus for moving book blocks in an apparatus for trimming book blocks

(75) Inventor: Mario Lorenzi, Villafranca-Padova (IT)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 10/836,500

(22) Filed: Apr. 30, 2004

(30) Foreign Application Priority Data
Apr. 30, 2003 (IT) MI2003 A 000876

(51) Int. Cl. B26D 7/06

(52) U.S. Cl. 83/151; 83/78; 83/452

(57) ABSTRACT

An apparatus is provided for moving book blocks in a triple cutter performing a front edge trim in a first position of the book block and a lateral edge trim in a second position of the book block. The apparatus has a first gripper which moves the book block into the first position and a second gripper which moves the book block into the second position. According to another embodiment, the triple cutter has a front blade and lateral blades and the apparatus has a conveyor table conveying a book block to a zero position. The conveyor table is mounted to pivot away and facilitate access to the front blade.

### BACKGROUND OF THE INVENTION

Field of the Invention

The invention relates to an apparatus for moving book blocks in a triple cutter performing a front edge trim in a first position of the book block and performing a lateral edge trim in a second position of the book block. The invention also relates to an apparatus for moving book blocks in a triple cutter having a front blade for performing a front edge trim in a first position of a book block and two lateral blades for performing a lateral edge trim in a second position of the book block.

Apparatuses of the stated type are typically used in order to move a book block, during a three-sided trimming operation of the latter, from a first cutting position, in which a front edge trim is performed, into a second position, in which a lateral edge trim is performed. The order can, however, also be exactly reversed. The cutting position of the front edge trim performed therein is usually variable, since the blade for the front edge trim is mostly installed fixed to the device and it is therefore only possible to influence the format of the trimmed book block in that extent using the cutting position of the front edge trim. The cutting position of the lateral edge trim is usually fixed, since the lateral blades can usually be displaced horizontally and symmetrically with respect to the center line of the transport path of a book block, and the lateral blades extend along the transport path to such an extent that it is possible to trim a large number of book blocks having different formats.

An apparatus of that generic type is disclosed, for example, in European Patent Application EP 1 132 183 A2. There, blade receiving plates are assigned to the lateral blades and mounted in such a way that the blade receiving plates can be displaced in interplay with the lateral blades. A gripper is displaceably mounted between the movable blade receiving plates, which moves the book block to be trimmed as far as the first and the second cutting positions.

However, it would be desirable to achieve a high cycle rate for a triple cutter and at the same time ensure reliable gripping of the book block at all times. Moreover, it would be desirable for the front blade, which is disposed transversely with respect to the transport path, to be more easily accessible and therefore for a blade change to be made easier.

### SUMMARY OF THE INVENTION

It is accordingly an object of the invention to provide an apparatus for moving book blocks in a device for trimming book blocks, which overcomes the hereinafore-mentioned disadvantages of the heretofore-known devices of this general type.

With the foregoing and other objects in view there is provided, in accordance with the invention, in a triple cutter for performing a front edge trim in a first position of a book block and for performing a lateral edge trim in a second position of the book block, an apparatus for moving the book blocks in the triple cutter. The apparatus comprises a first gripper moving a book block into the first position and a second gripper moving the book block into the second position.

As a result, it is possible to as much as double the speed at which the book blocks are processed by the apparatus for trimming book blocks, if the processing speed of the remaining components of the apparatus for trimming book blocks permits it.

In accordance with another feature of the invention, there is provided a controller which activates the drive of the first gripper in such a way that the first gripper moves the book block from a fixed zero position to a variable first position. The distance between the zero position and the first position corresponds to the distance from the book spine to the front edge of the trimmed book block. It is clear to a person skilled in the art that the cut sequence, that is to say first the front edge trim and then the lateral edge trim, can equally well be reversed.

In accordance with a further feature of the invention, there is provided a controller which activates a drive of the first gripper in such a way that the first gripper moves the book block from the first position into a predetermined transfer position. The transfer position is advantageously situated in front of the lateral blades, so that any clamping devices which are possibly present do not come into spatial conflict with the lateral blades.

In accordance with an added feature of the invention, there is provided a controller which activates a drive of the second gripper in such a way that the second gripper moves the book block from a predetermined transfer position into the second position.

In accordance with an additional feature of the invention, there is provided at least one signal generator which transmits the position of at least one of the grippers to a controller of the apparatus. In this case, it is advantageously the first gripper which moves to the variable cut position. The second gripper can likewise be equipped with a signal generator of this type. The signal generator is a signal generator which is known from the prior art in great numbers to a person skilled in the art, for instance an optical or magnetic sensor which reads off the position on an absolute scale.

In accordance with yet another feature of the invention, at least one of the grippers has an actuating device which lifts the book block in the gripper during transport from one position into another position. As a result, wear phenomena on the book block such as stripes, which otherwise are produced if the book block is dragged across the cutting base, are avoided. Dragging stripes are disadvantageously noticeable, in particular, in the case of black varnished book bindings. Both grippers advantageously have these actuating devices for lifting the book block during transport.

In accordance with yet a further feature of the invention, there is provided a first hold-down which presses the book block down over a large area before the front edge trim, in particular in order to press air out of the book block. This makes it possible for all of the pages of the book block to lie tightly and straight one above another. Thus, straight, high quality page areas of the book block are also produced by the trim.

In accordance with yet an added feature of the invention, the first hold-down has an elastic surface on the book block side. This is, for example, a foam, board or another compliant material. The provision of an elastic surface of this type protects the book block surface, inter alia, from traces which would otherwise be produced as a result of the book block being pressed down.

In accordance with yet an additional feature of the invention, there is provided a stop device which predefines the zero position for the book block. The zero position is to be understood herein as that position of the book spine from where the width of the trimmed book block is measured, in particular the necessary displacement path of the first gripper in order to reach the first cutting position. The stop device is advantageously moved into the transport path of the book block and moved out of the transport path again after aligning, in order to unblock the transport path again for transport of the book block.

In accordance with again another feature of the invention, there is provided a jogger device which jogs the book block straight in the zero position against the stop device. This ensures that the book spine also actually assumes the desired position and the front edge trim can accordingly be performed accurately. Moreover, the book spine is oriented at right angles to the transport direction as a result, which is important in order to obtain a right-angled book after all the trim operations have been performed. Transport elements which have moved the book block as far as the stop can be used, for example, as joggers.

In accordance with again a further feature of the invention, there is provided a second hold-down which is disposed in the vicinity of a transfer position. The second hold-down serves for fixing the book block in the transfer position, so that the book block always remains accurate in terms of position and angle, even during the transfer from the first to the second gripper, and it is accordingly possible to perform a clean book trimming operation. The second hold-down advantageously presses the book block down over its entire width transversely with respect to the transport direction. Accordingly, the apparatus advantageously has a controller which activates a drive of the second hold-down in such a way that the second hold-down holds down the book block when the first gripper has moved the book block into a transfer position, until the second gripper has gripped the book block in the transfer position. The drive of the second hold-down is, for example, a pneumatic drive.

In accordance with again an added feature of the invention, there is provided a controller which activates a drive of the first gripper and of the second gripper in such a way that the first gripper moves a book block from a zero position into the first position while the second gripper moves a preceding book block from a transfer position into the second position. As a result, the two grippers work in synchronism. A front edge trim and a lateral edge trim can therefore be performed simultaneously. This leads to the highest possible throughput of book blocks through the use of the apparatus according to the invention.

With the objects of the invention in view, there is also provided, in a triple cutter having a front blade for performing a front edge trim in a first position of a book block and two lateral blades for performing a lateral edge trim in a second position of the book block, an apparatus for moving the book blocks in the triple cutter. The apparatus comprises a conveyor table conveying a book block to a zero position. The conveyor table is mounted to pivot away and facilitate access to the front blade.

Since the front blade is situated transversely with respect to the transport path of a book block, it is usually extremely complicated to perform a blade change, because the transport path of the book block can only be interrupted with difficulty. A favorable point is the conveyor table of the feeder of a triple cutter. The conveyor table advantageously has at least one leg which is provided with a wheel, so that the rotary joint can be relieved. Additionally, the conveyor table advantageously has a locking device in order to lock the conveyor table in the operating position.

Other features which are considered as characteristic for the invention are set forth in the appended claims.

Although the invention is illustrated and described herein as embodied in an apparatus for moving book blocks in an apparatus for trimming book blocks, it is nevertheless not intended to be limited to the details shown, since various modifications and structural changes may be made to the invention without departing from the spirit of the invention and within the scope of the claims and the range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, perspective view of individual drives of an apparatus according to the invention;

FIG. 1B is a side-elevational view of the apparatus showing a transport path of book blocks;

FIGS. 2A-2L are elevational views illustrating a transport process and front edge trim in a triple cutter;

FIGS. 3A and 3B are elevational views of an embodiment of grippers of the apparatus according to the invention; and

FIGS. 4A and 4B are elevational views of an embodiment of a conveyor table of a triple cutter.

### DESCRIPTION OF THE PREFERRED EMBODIMENTS

The figures of the drawings and their description are limited to the elements which are important to the invention. Further drive, guide, and/or control devices and cam disks which are generally known and necessary to operate the apparatus are only shown diagrammatically or only described in general form. Identical designations identify identical parts in the individual drawings.

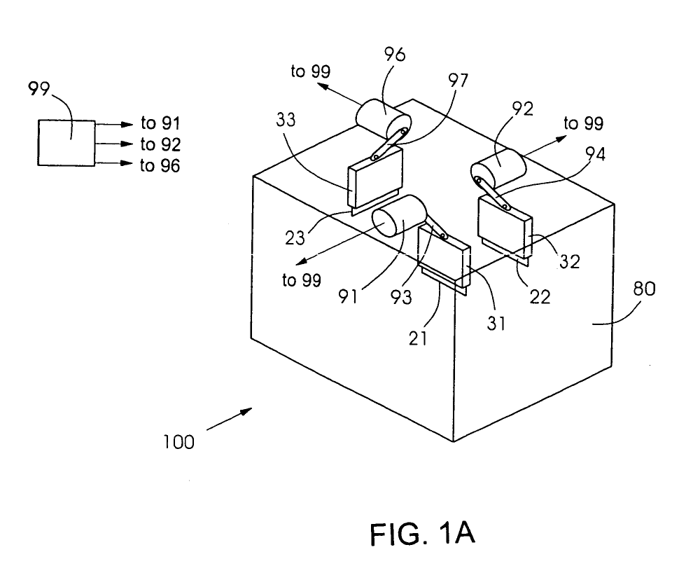

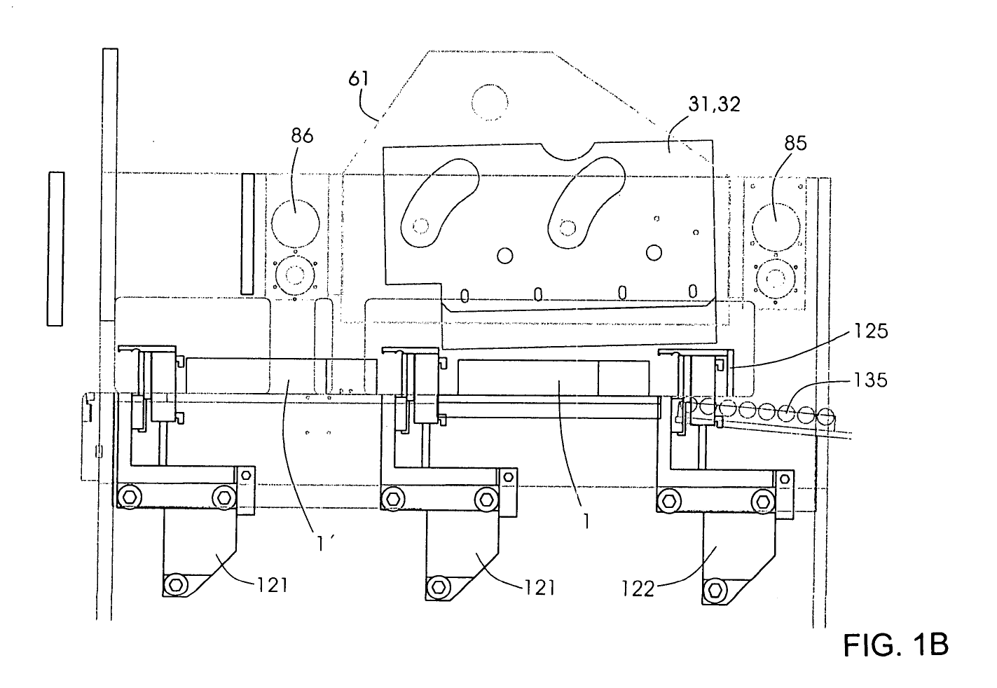

Referring now to the figures of the drawings in detail and first, particularly, to FIG. 1A thereof, there is seen a front blade holder 33 with an associated front blade 23 and two lateral blade holders 31, 32 with associated lateral blades 21, 22 disposed in a housing 80 of a triple cutter apparatus 100. Each of the blade holders 31, 32, 33 is associated with a respective drive 91, 92, 96 and is connected to a respective drive transmission element 93, 94, 97. Guide rods 85, 86 and a first blade holder housing 61 are also seen in FIG. 1B. A controller 99 activates the drives 91, 92, 96 to move the blade holders 31, 32, 33.

A book block 1, which is seen in FIG. 1B, is initially moved, in a manner dependent on its format, into a first cutting position relative to the front blade 23. After a front edge trim has been performed, the book block 1 is moved into a second cutting position in relation to the two lateral blades. After a lateral blade trim has been performed, the book block 1 is conveyed out of the triple cutter apparatus 100.

First and second grippers 121, 122, which are shown in the side view of FIG. 1B, transport the book block 1 into the first cutting position, into the second cutting position, into the triple cutter apparatus 100 and out of the triple cutter apparatus 100. The first gripper 121 is shown twice in order to illustrate the cutting position. The position which the first gripper 121 assumes in the center of FIG. 1B is a transfer position in which the book block 1, that is provided with a front edge trim, is transferred to the second gripper 122 in order to be moved into the second cutting position. The second gripper 122 has an ejection plate 125, with which the book block 1 can be pushed onto a delivery 135, while a book block 1′ is simultaneously drawn into the second cutting position.

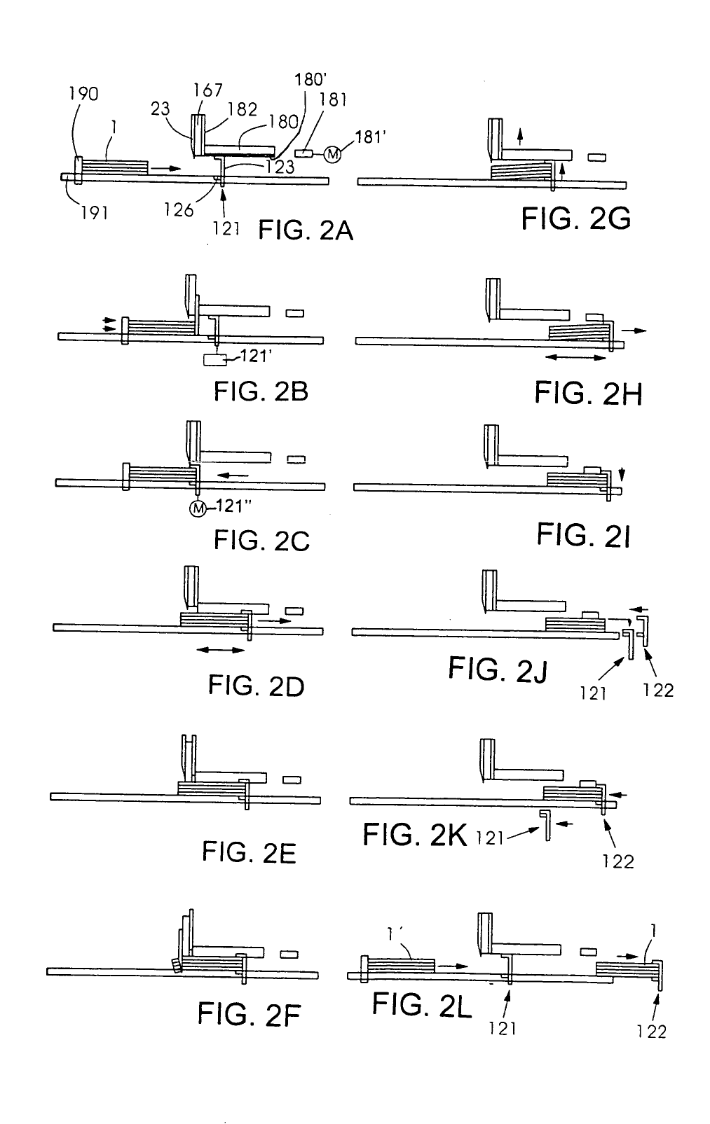

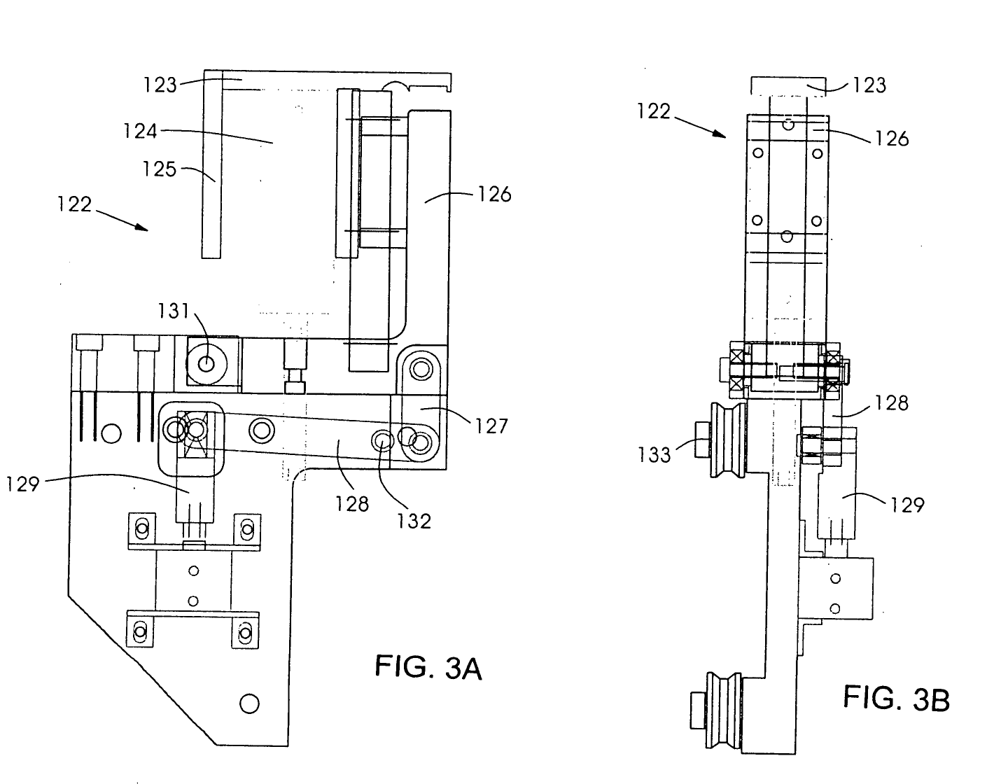

FIGS. 2A to 2L show a movement sequence of the first gripper 121 of the apparatus according to the invention and its interplay with the apparatus for performing a front edge trim and for the transfer to the second gripper 122. A book block 1 is pushed on a support 191, in particular a conveyor table 191, with its book spine to the front, by transport fingers 190, in a transport direction indicated by an arrow. The first gripper 121 is situated in its initial position, set away from the book block 1 and along a transport path behind a stop 182. In this position, the first gripper is, for example, open, that is to say an upper gripper limb 123 and a lower gripper limb 126 are set away from one another. In the exemplary embodiment shown, the upper gripper limb 123 can be lowered pneumatically in order to grip, and the lower and upper gripper limbs 123, 126 can be raised. Reference should also be made in this regard to the description of FIGS. 3A and 3B. As is shown in FIG. 2A, the front blade 23, a front blade hold-down 167, the stop 182, a first hold-down 180 with an elastic surface 180′ on the book block side, and a second hold-down 181 with a drive 181′ are situated at this instant in a passive position set away from the support 191.

As is shown in FIGS. 2A to 2L, there may be a book stack instead of an individual book block 1. Such a book stack includes a plurality of identical book blocks 1, four book blocks 1 in the example shown. It is possible for the processing speed of the apparatus for trimming the book blocks to be considerably increased in some circumstances by simultaneously processing a plurality of book blocks 1. Apparatuses of this type permit a certain book thickness, for example 6 cm, to be trimmed. Therefore, remaining with this example, it is also possible to simultaneously cut, for example, four or five book blocks 1 with a thickness of 1 cm. It should perhaps also be considered whether or not the material of the binding of a book block 1 has an influence on the total thickness which can be trimmed in one operation.

As is shown in FIG. 2B, the stop 182 is subsequently moved into the transport path and the book block 1 is transported against the stop and is jogged straight using joggers 190, which correspond to the transport fingers 190 in this embodiment. As a result, the book block 1 assumes its zero position. Subsequently, the first gripper 121 moves into its zero position shown in FIG. 2C and grips the book block 1 in such a way that it is possible to convey the book block 1 further at an accurate angle.

Subsequently, the book block 1 is moved into the first cutting position. In this case, the first gripper travels along a path which is identified by a double arrow and corresponds to the width of the book block 1. This distance is therefore a function of format. The first gripper has a signal generator 121′ shown in FIG. 2B which transmits the position of the first gripper 121 to the controller 99, so that the controller 99 can activate a drive 121″ shown in FIG. 2C of the first gripper 121 accordingly, permitting the required first cutting position to be moved to precisely. When the book block 1 is being moved, it is also possible for the first gripper 121 to have lifted the book block 1 in order to avoid unsightly dragging tracks on the book block 1.

As is shown in FIG. 2D, the first hold-down 180 then presses down the book block 1 in the first cutting position. This is done firstly in order to press air out of the book block 1 and secondly in order to make adequate fixing of the book block possible in order to absorb transverse forces which occur during trimming, for ensuring a clean cut. The cut is particularly good if the book block 1 is pressed down as close to the blade 23 as possible prior to the cut. This is why the front blade hold-down 167 initially presses down the book block 1, as is seen in FIG. 2E, before the cut is performed (see FIG. 2F).

After the front trim has been performed in this manner, the front blade 23, the front blade hold-down 167 and the first hold-down 180 move back into their initial position. The book spine is simultaneously lifted through the use of the first gripper and then drawn into the transfer position (see FIG. 2G and FIG. 2H) and lowered. In the transfer position, the book block 1 is additionally pressed down by the second hold-down 181, as indicated by an arrow in FIG. 2I, so that the orientation of the book block 1 remains preserved with an accurate angle and position.

Subsequently, the first gripper is released from the book block 1 and firstly moved backward and then under the book block 1 into its initial position again. Simultaneously, the second gripper 122 is moved to the book block 1, as is seen in FIGS. 2J, 2K and 2L. The second gripper 122 moves the book block 1 into the second cutting position, after the second gripper 122 has securely gripped the book block 1 and the second hold-down has released the book block 1 again. The first gripper 121 is then already waiting for the following book block 1′. The first gripper 121 has already been lowered at that instant at which the second gripper 122 comes into the vicinity of the book spine of the book block 1, so that there cannot be any collisions between the first gripper 121 and the second gripper 122.

The structures of the first gripper 121 and the second gripper 122 only differ substantially in the ejection plate 125 which the second gripper has and which serves to eject a book block 1, on which the lateral edge trim has already been performed, out of the apparatus for trimming book blocks 1. The construction of the grippers is shown in FIG. 3A and FIG. 3B. The upper gripper limb 123 is connected to the lower gripper limb 126 through the use of an upper gripper actuating element 124. The lower gripper limb 126 is rotatably mounted on a gripper limb pivot point 131. The lower gripper limb 126 can be pivoted about the pivot point 131 through the use of a lower gripper limb actuating element 129 and two rods 127, 128, one of the rods 128 being rotatable about a fastening element. As a result, it is possible for the gripping position of the two gripper limbs 123, 126 to be changed, for example raised. As a result, it is possible to lift the book block 1 at least in the region of the book spine, which prevents dragging tracks during a change between the positions of the book block 1. The grippers 121, 122 are provided with rollers 133 which are connected to a non-illustrated horizontal guide. The upper and lower gripper actuating elements 124, 129 are, for example, pneumatic cylinders. It is, however, likewise possible to use other actuating elements which are known to a person skilled in the art, for instance electric motors.

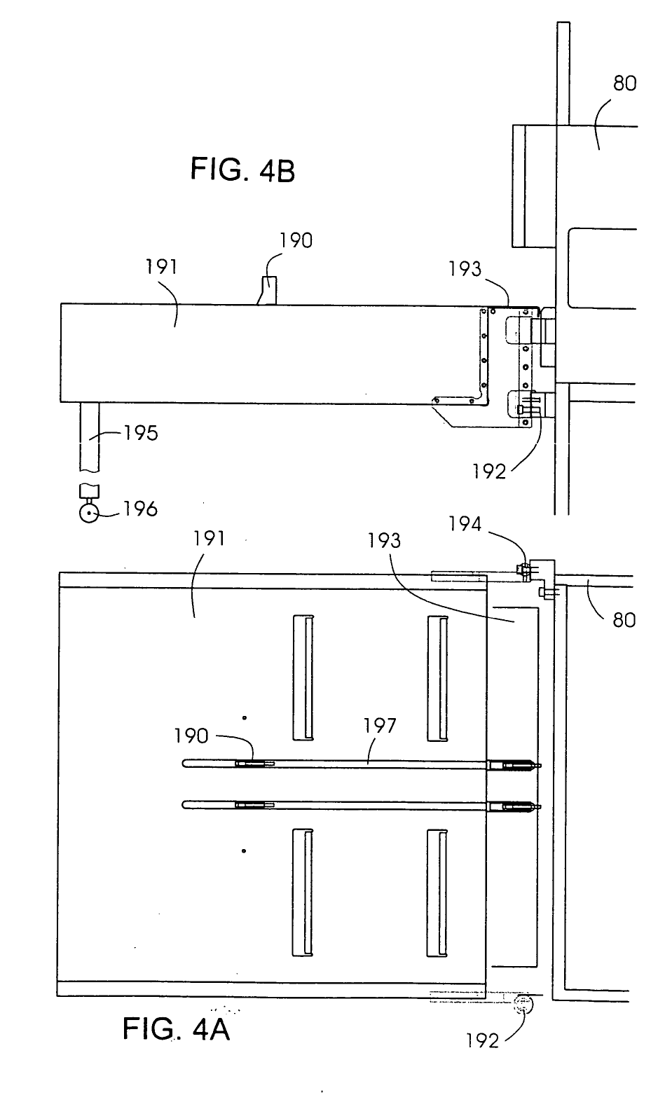

FIGS. 4A and 4B show details of the conveyor table 191 of an apparatus for moving book blocks 1 through an apparatus for trimming book blocks 1. The transport fingers 190 are guided in two parallel slots 197 in the conveyor table 191, which are disposed symmetrically with respect to a center line of the transport path. The transport fingers 190 are lowered before reaching the housing 80 of the triple cutter apparatus 100. A transition between the conveyor table 191 and the housing 80 is covered by a pivotably mounted bridging plate 193.

On one side, the conveyor table 191 has a joint 192, through which the conveyor table 191 is connected to the triple cutter apparatus 100. On the other side of the transport path, the conveyor table 191 has a locking device 194, with which it is possible to lock the conveyor table 191 in the working position, so that the conveyor table 191 is not inadvertently pivoted away from the housing 80 of the triple cutter apparatus 100 while the triple cutter apparatus 100 is operating. In order to ensure that the joint 192 is relieved, the conveyor table has at least one conveyor table leg 195 which is in contact with the floor through a wheel 196, so that firstly adequate support is achieved and secondly it is made easier to pivot the conveyor table 191 away. If the conveyor table is pivoted away, an operator has direct access to the front blade 23 and can thus comfortably perform a blade change or other maintenance work. Since the transport elements 121, 122, 190 are mechanically decoupled from one another at the connecting point between the conveyor table 191 and the triple cutter apparatus 100, no further measures at all need be taken apart from releasing or closing the locking device 194, in order to divide or unite the transport path at this location.

This application claims the priority, under 35 U.S.C. § 119, of Italian Patent Application No. MI2003 A 000876, filed Apr. 30, 2003; the entire disclosure of the prior application is herewith incorporated by reference.

1. In a triple cutter for performing a front edge trim in a first position of a book block and for performing a lateral edge trim in a second position of the book block, an apparatus for moving the book blocks in the triple cutter, the apparatus comprising:
a first gripper moving a book block into the first position and a second gripper moving the book block into the second position.

2. In a triple cutter having a front blade for performing a front edge trim in a first position of a book block and two lateral blades for performing a lateral edge trim in a second position of the book block, an apparatus for moving the book blocks in the triple cutter, the apparatus comprising:
a conveyor table conveying a book block to a zero position, said conveyor table being mounted to pivot away and facilitate access to the front blade.

3. The apparatus according to claim 1, which further comprises a controller activating a drive of said first gripper causing said first gripper to move the book block from a fixed zero position to a variable first position.

4. The apparatus according to claim 3, wherein the zero position and the first position are spaced apart by a distance corresponding to a distance from a book spine to a front edge of the trimmed book block.

5. The apparatus according to claim 2, which further comprises a first gripper moving the book block into a first position, a drive of said first gripper, a second gripper moving the book block into a second position, and a controller activating said drive of said first gripper causing said first gripper to move the book block from the fixed zero position to a variable first position.

6. The apparatus according to claim 5, wherein the zero position and the first position are spaced apart by a distance corresponding to a distance from a book spine to a front edge of the trimmed book block.

7. The apparatus according to claim 1, which further comprises a controller activating a drive of said first gripper causing said first gripper to move the book block from the first position into a predetermined transfer position.

8. The apparatus according to claim 2, which further comprises a first gripper moving the book block into the first position, a drive of said first gripper, a second gripper moving the book block into the second position, and a controller activating said drive of said first gripper causing said first gripper to move the book block from the first position into a predetermined transfer position.

9. The apparatus according to claim 1, which further comprises a controller activating a drive of said second gripper causing said second gripper to move the book block from a predetermined transfer position into the second position.

10. The apparatus according to claim 2, which further comprises a first gripper moving the book block into the first position, a second gripper moving the book block into the second position, a drive of said second gripper, and a controller activating said drive of said second gripper causing said second gripper to move the book block from a predetermined transfer position into the second position.

11. The apparatus according to claim 3, which further comprises at least one signal generator transmitting a position of at least one of said grippers to said controller.

12. The apparatus according to claim 5, which further comprises at least one signal generator transmitting a position of at least one of said grippers to said controller.

13. The apparatus according to claim 7, which further comprises at least one signal generator transmitting a position of at least one of said grippers to said controller.

14. The apparatus according to claim 8, which further comprises at least one signal generator transmitting a position of at least one of said grippers to said controller.

15. The apparatus according to claim 9, which further comprises at least one signal generator transmitting a position of at least one of said grippers to said controller.

16. The apparatus according to claim 10, which further comprises at least one signal generator transmitting a position of at least one of said grippers to said controller.

17. The apparatus according to claim 1, wherein at least one of said grippers has an actuating device lifting the book block in said at least one gripper during transport from one position into another position.

18. The apparatus according to claim 2, which further comprises a first gripper moving the book block into the first position, and a second gripper moving the book block into the second position, at least one of said grippers having an actuating device lifting the book block in said at least one gripper during transport from one position into another position.

19. The apparatus according to claim 1, which further comprises a first hold-down pressing the book block down over a large area before the front edge trim.

20. The apparatus according to claim 19, wherein said first hold-down presses air out of the book block.

21. The apparatus according to claim 2, which further comprises a first gripper moving the book block into the first position, a second gripper moving the book block into the second position, and a first hold-down pressing the book block down over a large area before the front edge trim.

22. The apparatus according to claim 21, wherein said first hold-down presses air out of the book block.

23. The apparatus according to claim 19, wherein said first hold-down has a book block side and an elastic surface on said book block side.

24. The apparatus according to claim 21, wherein said first hold-down has a book block side and an elastic surface on said book block side.

25. The apparatus according to claim 1, which further comprises a stop device predefining a zero position for the book block.

26. The apparatus according to claim 2, which further comprises a first gripper moving the book block into the first position, a second gripper moving the book block into the second position, and a stop device predefining the zero position for the book block.

27. The apparatus according to claim 25, which further comprises a jogger device jogging the book block straight in the zero position against said stop device.

28. The apparatus according to claim 26, which further comprises a jogger device jogging the book block straight in the zero position against said stop device.

29. The apparatus according to claim 25, wherein said stop device is mounted for movement into a transport path of the book block.

30. The apparatus according to claim 26, wherein said stop device is mounted for movement into a transport path of the book block.

31. The apparatus according to claim 1, which further comprises a second hold-down disposed in vicinity of a transfer position.

32. The apparatus according to claim 2, which further comprises a first gripper moving the book block into the first position, a second gripper moving the book block into the second position, and a second hold-down disposed in vicinity of a transfer position.

33. The apparatus according to claim 31, which further comprises a drive of said second hold-down, and a controller activating said drive of said second hold-down causing said second hold-down to hold down the book block when said first gripper has moved the book block into a transfer position until said second gripper has gripped the book block in the transfer position.

34. The apparatus according to claim 32, which further comprises a drive of said second hold-down, and a controller activating said drive of said second hold-down causing said second hold-down to hold down the book block when said first gripper has moved the book block into a transfer position until said second gripper has gripped the book block in the transfer position.

35. The apparatus according to claim 1, which further comprises a controller activating a drive of said first gripper and of said second gripper causing said first gripper to move a book block from a zero position into the first position while said second gripper moves a preceding book block from a transfer position into the second position.

36. The apparatus according to claim 2, which further comprises a first gripper moving the book block into the first position, a drive of said first gripper, a second gripper moving the book block into the second position, a drive of said second gripper, and a controller activating said drive of said first gripper and said drive of said second gripper causing said first gripper to move a book block from the zero position into the first position while said second gripper moves a preceding book block from a transfer position into the second position.

37. The apparatus according to claim 1, which further comprises a conveyor table conveying the book block to a zero position, said conveyor table having at least one leg provided with a wheel.

38. The apparatus according to claim 2, wherein said conveyor table has at least one leg provided with a wheel.

39. The apparatus according to claim 1, which further comprises a conveyor table conveying the book block to a zero position, said conveyor table having a locking device for locking said conveyor table in an operating position.

40. The apparatus according to claim 2, wherein said conveyor table has a locking device for locking said conveyor table in an operating position.
